(19) United States
(12) Patent Application Publication
(10) Pub. No.: US 2004/0189575 A1
(43) Pub. Date: Sep. 30, 2004

(54) Method for driving liquid crystal display in dot inversion

(76) Inventors: Yu Jin Choi, Kyoungki-do (KR); Jin Young Jeong, Kyoungki-do (KR)

Correspondence Address: LADAS & PARRY, 224 SOUTH MICHIGAN AVENUE, SUITE 1200, CHICAGO, IL, 60604, US

(21) Appl. No.: 10/626,900

(22) Filed: Jul. 22, 2003

(30) Foreign Application Priority Data
Mar. 31, 2003 (KR) 2003-20192

(51) Int. Cl. G09G 3/36

(52) U.S. Cl. 345/96

(57) ABSTRACT

Disclosed is a method for driving a liquid crystal display in a dot inversion. In a method for driving a liquid crystal panel in a dot inversion in a liquid crystal panel which has a plurality of sets, each set having a plurality of R, G, B dot columns, each of the R, G, B dot columns having a plurality of dots which are arranged in a matrix, the dots are inverted in sets of a plurality of R, G, B dot columns. R,G, B dot columns of one of the sets are driven to have a polarity contrary to R, G, B dot columns of an adjacent set in inversion. R, G, B dot columns in the same set in two dot columns are driven in inversion.

### BACKGROUND OF THE INVENTION

1. Field of the Invention

The present invention relates to a method for driving a liquid crystal display in a dot inversion, and more particularly to a method for driving a liquid crystal display which eliminates a greenish phenomenon indicating a phenomenon in which a screen becomes dim.

2. Description of the Prior Art

As generally known in the art, in order to drive a liquid crystal display panel, an input driving voltage is inverted by three driving methods, such as a frame inversion system, a line inversion system, and a dot inversion system. The reason is that electric and chemical changes occur in pixels and opposed electrodes, thereby lowering a display sensitivity and a brightness of a screen since ionic impurities are deposited in a liquid crystal material when a driving voltage of the same polarity continues to be applied to a liquid crystal cell.

Therefore, in order to solve the above problems, an inversion driving method has been used. The inversion driving method is a method which periodically inverts a polarity of a voltage applied to a liquid crystal cell.

In particular, an inversion driving method inverting the polarity of the voltage in single pixels is referred to as one dot inversion driving method. Polarities of data signals supplied to the liquid crystal panel are inverted every source line, every gate line, and every frame.

FIG. 1 is a view showing a dot pattern according to a conventional dot inversion driving method. As shown in FIG. 1, the dot pattern according to the conventional dot inversion driving method includes a plurality of dots in which R, G, and B dot columns are repeatedly arranged in a horizontal line direction.

In the first horizontal line of FIG. 1, after the first dot 1 is charged with a positive (+) polarity, when the second dot 2 is inverted into a negative (−) polarity, an alternating current signal through a parasitic capacitance between pixel electrodes is generated to lower a charging rate of a pixel electrode of the second dot 2. In a similar manner, after all dots on the first horizontal line are charged, when the first dot in the second horizontal line is charged, a charging rate of a corresponding pixel electrode due to an inversion of a polarity.

Accordingly, in comparison with the first dot 1, since a brightness of the second dot 2 is reduced due to a drop of the charging rate, a dim brightness difference in pixels, that is, a greenish phenomenon occurs on the screen. FIG. 2 is a waveform view which shows a waveform obtained by the conventional dot inversion driving method. As shown in FIG. 2, since voltages applied to each dot 1, 2, 3/4, 5, 6 are asymmetrically charged according to a polarity inversion, a parasitic capacitance is generated in a pixel electrode to distort a common voltage signal Vcom.

### SUMMARY OF THE INVENTION

Accordingly, the present invention has been made to solve the above-mentioned problems occurring in the prior art, and an object of the present invention is to provide a method for driving a liquid crystal display in a dot inversion which prevent a greenish phenomenon by eliminating a distortion of a common voltage signal using two dot inversion driving method and a transformed dot inversion driving method thereof wherein the two dot inversion driving method which inverts dots in two columns.

In order to achiever the object, there is provided a method for driving a liquid crystal panel in a dot inversion in a liquid crystal panel which has a plurality of sets, each set having a plurality of R, G, B dot columns, each of the R, G, B dot columns having a plurality of dots which are arranged in a matrix, the method comprising the steps of: inverting the dots in sets of a plurality of R, G, B dot columns; driving R,G, B dot columns of one of the sets to have a polarity contrary to R, G, B dot columns of an adjacent set in inversion; and driving the R, G, B dot columns in the same set in two dot columns in inversion.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a dot pattern according to a conventional dot inversion driving method;

FIG. 2 is a waveform view which shows a waveform obtained by the conventional dot inversion driving method;

FIG. 3 is a view for showing a dot pattern according to an embodiment of the present invention; and

FIG. 4 is a view for showing a dot pattern according to another embodiment of the present invention.

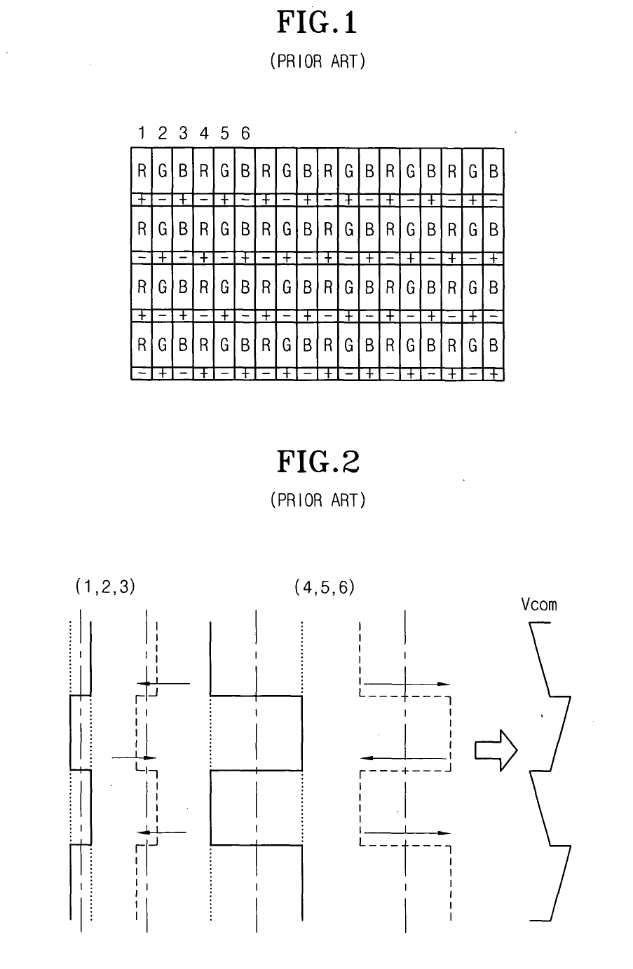

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

Hereinafter, a two-dot inversion driving method of a liquid crystal display device according to the present invention will be described.

The liquid crystal display device includes a plurality of pixels in which a plurality of gate lines, a plurality of data lines, and a thin film transistor are arranged in a column form. A plurality of the data lines cross a plurality of gate lines. The thin film transistor is formed at an area in which the data lines cross the gate lines. Each pixel is formed by R, G, and B dots. The R, G, and B dots are arranged on a liquid crystal panel in a column direction.

As is generally known, in a method for driving the liquid crystal display device, a controller generates a driving signal which driving a liquid crystal panel in inversion. The driving signal is provided to a source driver and a gate driver. The source driver and the gate driver are installed at side portions of the liquid crystal panel. The source driver provides a gradation voltage corresponding to the driving signal from the controller to a source line.

The present invention uses a two dot inversion driving method to prevent a greenish phenomenon occurring in the one dot inversion driving method.

In the two dot inversion driving method according to the present invention, a liquid crystal panel which has a plurality of sets. Each of the sets has four R, G, B dot columns. Each of the R, G, B dot columns has a plurality of dots which are arranged in matrix. The dots are inverted in sets of 4 R, G, B dot columns. R,G, B dot columns of one of the sets to have a polarity contrary to R, G, B dot columns of an adjacent set are driven in inversion. The R, G, B dot columns in the same set are driven in two dot columns in inversion. When one frame has 4 horizontal lines, one set has 48 dots (4×12=48).

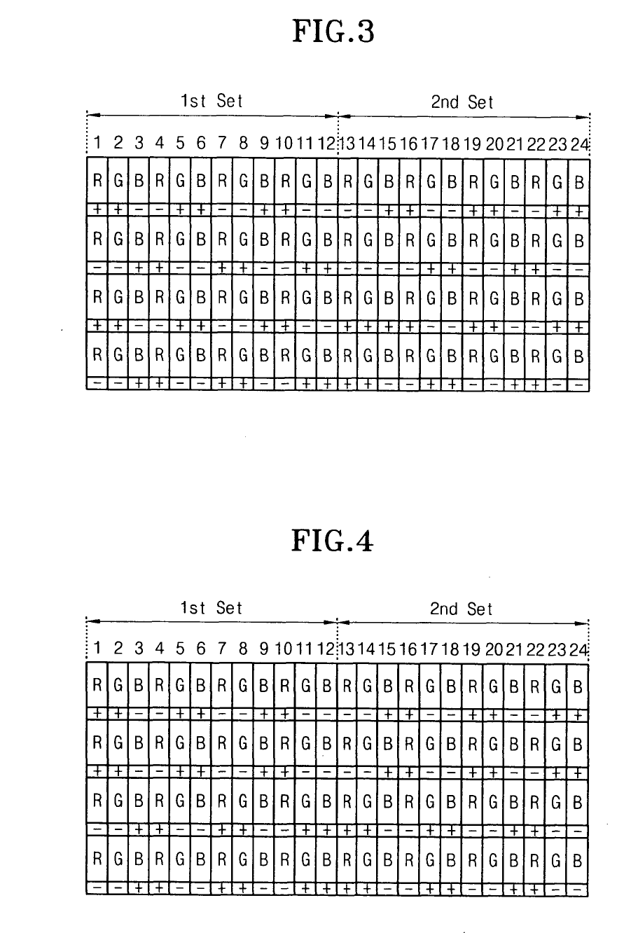

FIG. 3 is a view for showing a dot pattern according to an embodiment of the present invention.

In FIG. 3, R, G, B dot columns are driven in two dot columns in inversion. The R, G, B dot columns are driven in one horizontal line in a dot inversion.

In a horizontal line, one set is formed by 12 dot columns 1˜12. Each dot in the first set is driven in inversion to have a polarity contrary to a corresponding dot of an adjacent set (the second set) 13˜24.

When the first dot R and the second dot G in the first set of the first horizontal line are driven with positive (+) polarities, the third dot B and the fourth dot R therein are driven with negative (−) polarities. In the first column line of the first set, when the first dot R is driven with a positive (+) polarity, the second dot R is driven with a negative (−) polarity.

FIG. 4 is a view for showing a dot pattern according to another embodiment of the present invention.

In FIG. 4, R, G, B dot columns are driven in two dot columns in inversion. The R, G, B dot columns is driven in one horizontal line in a dot inversion.

In a horizontal line, one set is formed by 12 dot columns 1˜12. Each dot in the first set is driven in inversion to have a polarity contrary to a corresponding dot of an adjacent set (the second set) 13˜24.

When the first dot R and the second dot G in the first set of the first horizontal line are driven with positive (+) polarities, the third dot B and the fourth dot R therein are driven with negative (−) polarities. In the first column line of the first set, when the first dot R and second dot R are driven with positive (+) polarities, the third dot R and fourth dot R are driven with negative (−) polarities.

When 2 dot inversion driving method is used to drive the liquid crystal display device, a charging amount difference between pixels is reduced, and a distortion of a common voltage signal is reduced.

With accordance to the method for driving a liquid crystal display in a dot inversion according to the present invention, by reducing a distortion of a common voltage signal generated due to a charging amount difference between pixels using a two dot inversion driving method, a greenish color displayed on a screen is prevented without changing a design of a liquid crystal panel to obtain a good quality of picture in a liquid crystal display device.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for driving a liquid crystal panel in a dot inversion in a liquid crystal panel which has a plurality of sets, each set having a plurality of R, G, B dot columns, each of the R, G, B dot columns having a plurality of dots which are arranged in a matrix, the method comprising the steps of:
inverting the dots in sets of a plurality of R, G, B dot columns;
driving R,G, B dot columns of one of the sets to have a polarity contrary to R, G, B dot columns of an adjacent set in inversion; and
driving the R, G, B dot columns in the same set in two dot columns in inversion.

2. A method according to claim 1, wherein the set of the R, G, B dot columns include four R, G, B dot columns.

3. A method according to claim 1, wherein the R, G, B dot columns are driven in one horizontal line direction in inversion.

4. A method according to claim 1, wherein the R, G, B dot columns are driven in two horizontal line directions in inversion.
